(19) United States
(12) Patent Application Publication
(10) Pub. No.: US 2004/0201192 A1
(43) Pub. Date: Oct. 14, 2004

(54) Kneeling walker systems and methods

(76) Inventor: Sharalyn S. Ramm, Edmonds, WA (US)

Correspondence Address: MICHAEL R. SCHACHT, Suite 202, 2801 Meridian Street, Bellingham, WA, 98225-2400, US

(21) Appl. No.: 10/410,028

(22) Filed: Apr. 8, 2003

(51) Int. Cl. B62M 1/00

(52) U.S. Cl. 280/87.021

(57) ABSTRACT

A walker system comprising a frame, a handle, a plurality of wheel assemblies, a pad assembly, and a post locking member. The frame comprises a pad support. The handle is supported.by the frame. The wheel assemblies support the frame. The pad assembly comprises a pad member and a pad post. The pad support slidably supports the pad post such that a position of the pad member relative to the frame can be changed. The post locking member secures the pad post relative to the pad support to substantially fix the position of the pad member relative to the frame. Optionally, the handle member can be slidably mounted to the frame for movement between lower and upper positions.

### TECHNICAL FIELD

The present invention relates to walker systems and methods and, in particular, to kneeling walker systems and methods that support one leg while being propelled using the other leg.

### BACKGROUND OF THE INVENTION

Numerous devices have been created to provide and enhance mobility to individuals with physical disabilities. Two common examples of such devices are wheel chairs and walkers. The present invention relates to a special class of devices for assisting disabled persons that combine aspects of a walker with aspects of a wheelchair. In particular, certain individuals have disabilities where only one leg is disabled. Persons with one good and one disable leg use a wheeled device often referred to as a kneeling walker.

A kneeling walker typically comprises a frame that is supported by a plurality of wheels. A handle extends upward from the frame, and a kneeling pad is supported by the frame at a convenient location. In use, the user places the disabled leg on the knee pad and grasps the handle. The user then pushes with the good leg to propel the device. The frame carries the user's weight from the knee pad to the wheel assemblies so that the user moves along with the kneeling walker device. The handle is typically a fixed member that provides support to the user. While the handle does not turn the wheels, the handle can assist the user in turning the kneeling walker by allowing the user to slightly lift the front or rear wheels as necessary to change the direction of the kneeling walker. Often, a hand operated brake is provided to allow the user to slow or stop the kneeling walker; the hand brake is typically used in addition to a stopping force applied by the good leg.

While the basic concepts of the kneeling walker are known, the need exists for assemblies that are easy to use, can be adjusted to accommodate users of different sizes, and are foldable for storage and/or transportation.

### SUMMARY OF THE INVENTION

The present invention may be embodied as a walker system comprising a frame, a handle, a plurality of wheel assemblies, a pad assembly, and a post locking member. The frame comprises a pad support. The handle is supported by the frame. The wheel assemblies support the frame. The pad assembly comprises a pad member and a pad post. The pad support slidably supports the pad post such that a position of the pad member relative to the frame can be changed. The post locking member secures the pad post relative to the pad support to substantially fix the position of the pad member relative to the frame. Optionally, the handle member can be slidably mounted to the frame for movement between lower and upper positions.

The present invention may also be embodied as a method of supporting an elevated leg. A frame comprising a pad support is provided. A handle is supported on the frame. A plurality of wheel assemblies are provided to support the frame. A pad assembly comprising a pad member and a pad post is also provided. The pad post is slidably supported on the pad support such that a position of the pad member relative to the frame can be changed. The pad post is secured relative to the pad support to substantially fix the position of the pad member relative to the frame at a desired location.

### BRIEF DESCRIPTION OF THE DRAWINGS

FIG. 1 is a side elevation view of a kneeling walker assembly of the present invention being used to assist a user in moving along a surface;

FIG. 2 is a side elevation view of the kneeling walker of FIG. 1 illustrating a handle and pad assembly in lower positions relative to the frame;

FIG. 3 is a top plan view of the kneeling walker assembly of FIG. 1;

FIG. 4 is a side elevation view similar to that of FIG. 2 depicting a handle and pad assembly in upper positions relative to the frame;

FIG. 5 is a side elevation view depicting the kneeling walker as shown in FIG. 2 in a folded or storage configuration; and

FIG. 6 is a side elevation view depicting a brake assembly that may be used in conjunction with a kneeling walker as depicted in FIG. 2.

### DETAILED DESCRIPTION OF THE INVENTION

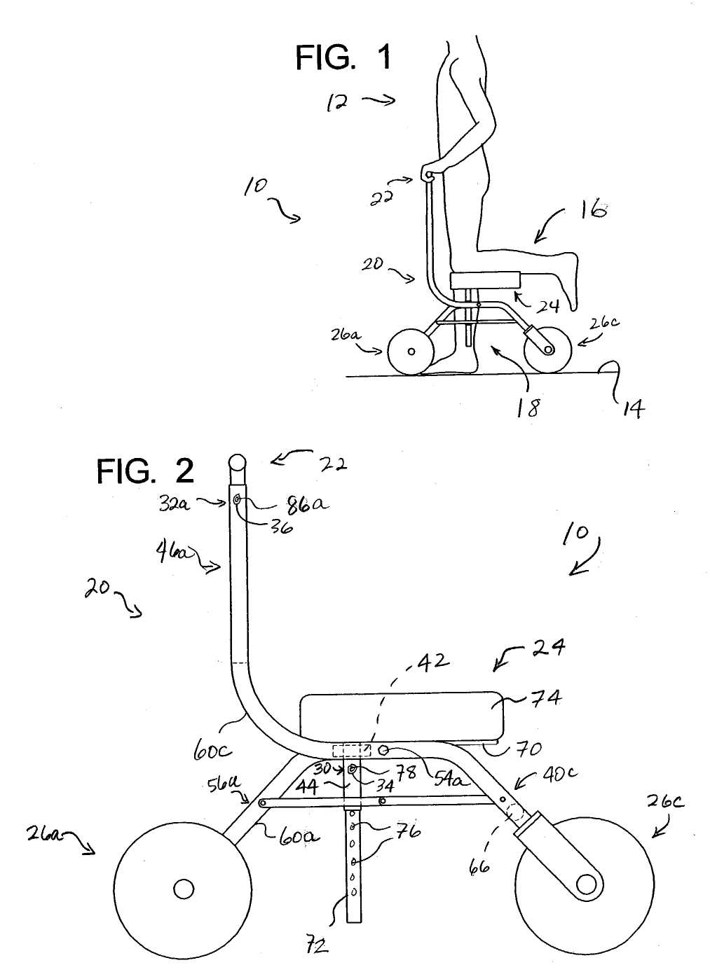

Referring initially to FIG. 1, depicted at 10 therein is a kneeling walker constructed in accordance with, and in embodying, the principles of the present invention. The kneeling walker 10 is shown facilitating a movement of a person 12 along a surface 14. The user 12 is supporting an elevated leg 16 on the kneeling walker 10. In addition, the user is using a good or pushing leg 18 to push the user and the kneeling walker 10 along the surface 14. In this sense, the kneeling walker 10 may be used in a manner that is generally similar to that of conventional prior art kneeling walkers.

The principles of the present invention are of primary importance in the construction and adjustment of the walker 10 and not in the actual use of this walker. To the contrary, the actual use of the walker will depend in large part on the needs of the user 12. The use of the walker 10 by the user 12 will thus will not be described in detail herein.

The walker 10 comprises a frame 20 on which is mounted a handle 22 and a pad assembly 24. The frame 20 is supported by a plurality of wheel assemblies 26 for rolling movement along the surface 14. As generally shown in FIG. 1, the user 12 supports the knee of the elevated leg 16 on the pad assembly 24. Most of the weight of the user 12 is carried though the pad assembly 24, the frame 20, and the wheel assemblies 26 to the surface 14. The user 12 grasps the handle 22 for stability. The user then pushes with the pushing leg 18 to cause the kneeling walker 10, and the user 12 carried thereby, to move a short distance along the surface 14. This process is repeated until the user 12 reaches a destination point.

The handle 22 and the pad assembly 24 are both adjustable relative to the frame 20. In particular, FIG. 4 illustrates the pad assembly 24 in an upper most position while FIG. 6 illustrates the pad assembly 24 in a lowermost position. Similarly, FIG. 4 illustrates the handle 22 in an uppermost position, while FIG. 6 illustrates the handle 22 in a lowermost position. Both the handle 22 and the pad assembly 24 can be locked into intermediate positions between the uppermost and the lowermost positions shown in FIG. 4 and FIG. 6 respectively.

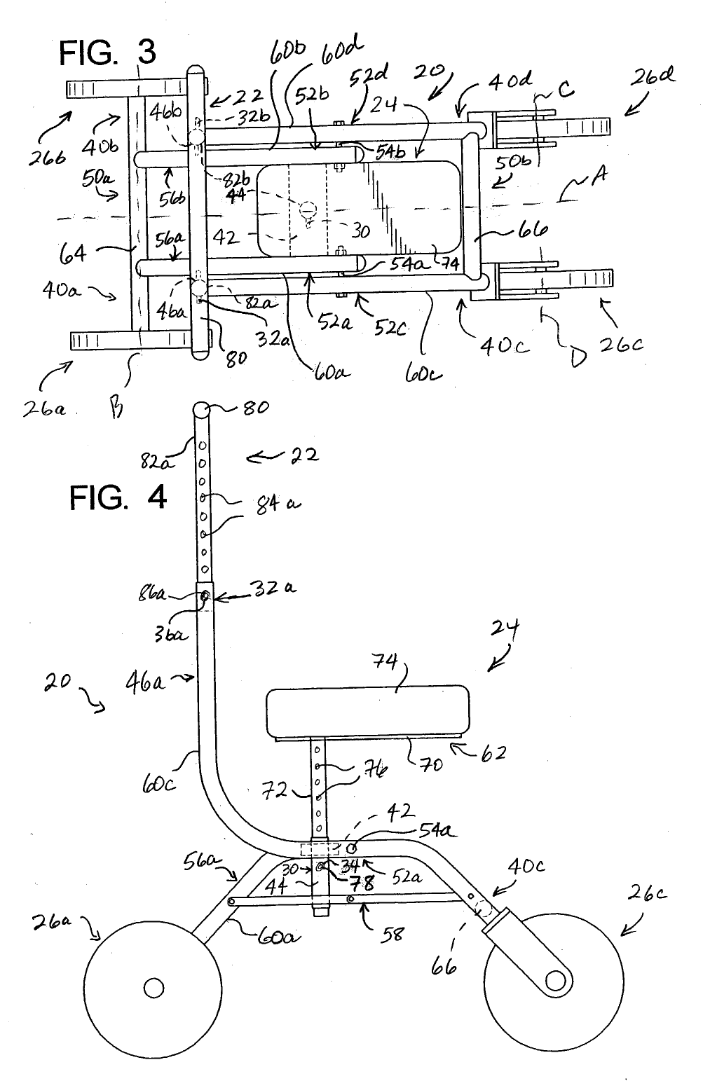

More specifically, FIGS. 2-4 show that a post locking assembly 30 is provided to secure a position of the pad assembly 24 relative to the frame 20. Similarly, at least one handle locking assembly 32 is used to secure the handle 22 relative to the frame 20. FIGS. 2 and 4 show that a post locking hole 34 is formed in the exemplary frame 20 to allow the post locking assembly to secure the pad assembly 24 in any one of a plurality of positions relative to the frame 20. Similarly, FIGS. 2 and 4 show that one or more handle locking holes 36 may be formed in the frame 20 to allow the handle 22 to be secured in one of the plurality of positions relative to the frame 20. As perhaps best shown in FIG. 3, the exemplary kneeling walker 10 comprises first and second handle locking assemblies 32a and 32b and first and second handle locking holes 36a and 36b.

Referring specifically to FIG. 3, the frame 20 comprises first and second front leg portions 40a and 40b at which first and second front wheel assemblies 26a and 26b are located. The frame also defines first and second rear leg portions 40c and 40d at which first and second rear wheel assemblies 26c and 26b are located. The frame exemplary 20 further comprises a support plate 42 from which is suspended a support tube 44. The support tube 44 slidably supports the pad assembly 24 as will be described in further detail below.

As perhaps best shown in FIG. 3, the frame 20 further comprises two handle support portions 46a and 46b. The handle support portions 46a and 46b engage and support the handle 22 for movement between the lower and uppermost positions described above.

FIG. 3 further shows that the frame 20 comprises a front frame assembly 50a and a handle frame assembly 50b. The front frame assembly 50a defines first and second hinge portions 52a and 52b, while the handle frame assembly 50b defines third and fourth hinge portions 52c and 52d. First and second hinge members 54a and 54b extend through the hinge portions 52 to rotatably attach the front frame assembly 50a to the handle frame assembly 50b. In particular, the first hinge member 50a extends through the first and third hinge portions 52a and 52c, while the second hinge member 54b extends through the second and fourth hinge portions 52b and 52d.

The front frame assembly 50a further comprises first and second front portions 56a and 56b that extend between the first and second hinge portions 52a and 52b and the first and second leg portions 40a and 40b.

First and second locking assemblies 58a and 58b extend between the front portions 56a and 56b of the front frame assembly 50a and the first and second rear leg portions 40c and 40d, which are formed by the handle frame assembly 50b.

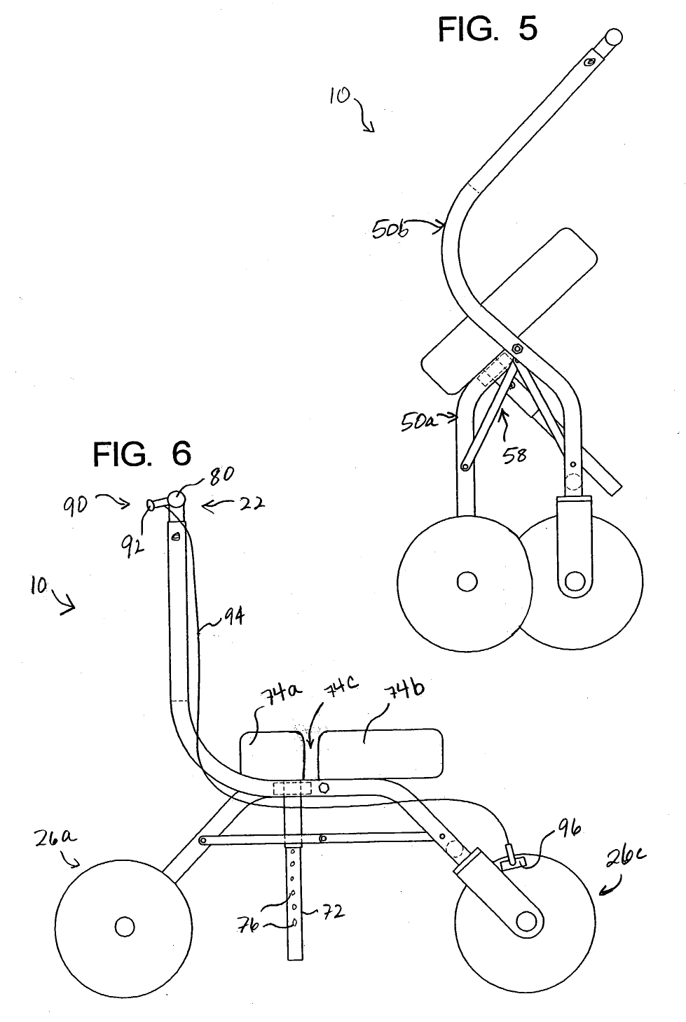

The hinge members 54a and 54b allow the front and handle frame assemblies 50a and 50b to pivot relative to each other between a use configuration as shown in FIGS. 2 and 4 and a storage configuration as shown in FIG. 5. The frame locking assemblies 58a and 58b conventionally comprise two bars that are pivotally connected to each other and to the frame assemblies 50a and 50b for movement between a locked configuration as shown in FIG. 4 and an unlocked configuration as shown in FIG. 5. In the locked configuration, the frame locking assemblies 58a and 58b prevent the front portion 56a and 56b from moving forward relative to the rear leg portions 40c and 40d. However, the frame locking assemblies 58a and 58b can be pivoted upward to allow the front portions 56a and 56b to move towards the rear leg portions 40a and 40b such that the frame 20 collapses into the storage configuration of FIG. 5.

With the foregoing general understanding of the construction and operation of the present invention, the exemplary frame 20, handle 22, and pad assembly 24 will now be described in further detail.

As generally described above, the frame comprises front and handle frame assemblies 50a and 50b that are rotatably connected by two hinge members 54. The frame assemblies 50a and 50b are typically formed of lightweight metal tubes that are bent into a desired configuration and then welded together to obtain the frame assembly.

In particular, the exemplary front frame assembly 50a comprises first and second front frame side members 60a and 60b. The front frame side member 60a and 60b are formed of a metal tube that is bent at an angle of approximately between 110° and 160°. The front frame side members 60 form the first and second hinge portions 52a and 52b and the front portions 56a and 56b of the frame 20.

The pad support plate 42 is welded between the first and second hinge portions 52a and 52b. The pad support tube 44 is welded to the pad support plate at a location between the first and second hinge portions 52a and 52b. A wheel support member 64 is formed by a hollow tube welded to the first and second front portions 56a and 56b; the wheel support member 64 forms the first and second front leg portions 40a and 40b described above.

The handle frame assembly 50b comprises first and second handle frame side members 60c and 60d. The handle frame side members 60c and 60d are hollow metal tubes that are bent at two locations. The first bend is a fairly large radius 90° turn, while the second bend is a somewhat tighter radius bend of approximately 110° to 160°. So formed, the handle frame side members 60a and 60d form the handle support portions 46a and 46b, the hinge portions 52c and 52d, and the first and second rear leg portions 40c and 40d.

The handle frame assembly 50b further comprises at least one brace member 66 welded between the first and second handle frame side members 60c and 60d.

The exemplary pad assembly 24 of the present invention comprises a pad plate 70, a pad post 72, and a pad 74. The pad 74 is a resilient foam pad that provides a comfortable support for resting the knee of the elevated leg 16 during use of the kneeling walker 10. The pad plate 70 is simply a rigid, usually metal, plate that provides structural integrity to the otherwise flexible pad 74. The pad post 72 is a metal tube that is secured by welding or the like to the bottom of the pad plate 70.

The pad post 72 is sized and dimensioned to be received within the support tube 44 described above. The support tube 44 receives the pad post 72 in a manner similar to that of a conventional bicycle seat. The location of the pad 74 relative to, for example, the hinge portions 52 of the frame 20 can be adjusted by sliding the pad post 72 within the support tube 44.

The post locking assembly 30 can be formed of any system capable of securing the pad post 72 relative to the support tube 44 to hold the pad 74 in a desired orientation relative to the frame 20. For example, a split may be formed in the support tube 44, and a cam lever may be provided to force opposing portions of the support tube 44 together. These opposing portions of the support tube 44 frictionally engage the pad post 72 and inhibit movement of the post 72 relative to the tube 44. This type of post locking assembly will be referred to herein as a friction type locking assembly. A friction type post locking assembly is typically easy to operate and allows the pad 74 to be located at any one of a continuum of locations relative to the frame 20.

Alternatively, the post locking assembly 30 may be formed by a series of pad post locking holes formed in the pad post 72 and a pad post locking member 78 that extends through the post locking hole 34 and a selected one of the pad post locking holes 76. This type of post locking assembly will be referred to as a pin type locking assembly. The pin type locking assembly provides a positive lock between the pad post 72 and support tube 44.

Referring for a moment back to FIG. 3, the handle 22 will be described in further detail. The exemplary handle 22 comprises a handle member 80 and first and second handle posts 82a and 82b. The handle member 80 and the handle posts 82 are formed of hollow steel tubes, with the handle posts 82a and 82b being welded at symmetrically spaced locations along, and extending parallel from, the handle member 80. In addition, the handle posts 82 are sized and dimensioned to fit within the tubes forming the handle support portions 46a and 46b of the handle frame side members 60c and 60d. In particular, the lateral spacing of the handle frame side members 60c and 60d and the distance between the handle posts 82a and 82b are substantially the same such that the handle posts 82a and 82b; the handle posts 82a and 82b are thus slidingly received within the handle support portions 46a and 46b of the handle frame side members 60c and 60d.

The handle locking assemblies 32a and 32b are formed at the intersections of the handle posts 82 and the handle support portions 46 to secure the handle member 80 in a desired location relative to the frame 20 and the pad 74. The handle locking assemblies 32 may be formed of friction type locking assemblies as generally described above.

Alternatively, as shown in FIGS. 2 and 4, the handle locking assemblies 32 may be formed by handle post locking holes 84 formed in the handle posts 82 and handle post locking members 86a and 86b. The handle post locking members 86a and 86b extend through the handle locking holes 36a and 36b and a selected pair of the handle post locking holes 84 to secure the handle member 80 in a desired relationship to the frame 20.

When the kneeling walker 10 is in the use configuration as shown in FIGS. 2 and 4, it can be seen that the hinge portions 52a-d are all substantially parallel to each other. In addition, the large radius bend in the handle frame side members 60c and 60d causes the handle support portions 46a and 46b to extend upward in front of the pad 74 during normal use. The frame 20 is thus configured such that no portion of the frame extends to either side, or to the rear, of the pad 74 during normal use. This allows the user 12 to have complete and unrestricted access to the pad 74 from the rear and from both sides. While the present invention in its broadest form may be embodied with other frame configurations, the exemplary frame 20 is preferably because it allows substantially unrestricted access to the pad 74 during normal use.

Referring now to FIG. 6, depicted therein is a braking system 90 that may be used in connection with kneeling walker 10. The brake system 90 comprises a brake handle 92 attached to the handle member 80. A brake cable 94 extends from the brake handle 92 to a brake member 96. Displacing the brake handle 92 relative to the handle member 80 by squeezing or the like causes displacement of the brake member 96 such that the brake 96 frictionally engages the wheel assembly 26c to inhibit rotation of the wheel assembly 26c. The brake system 90 can take any one of a number of forms and is similar in construction to the brake assembly used by conventional bicycles.

FIG. 6 also shows that the pad assembly 24 of the kneeling walker of FIG. 6 comprises first and second pad portions 74a and 74b with a pad gap 74c arranged therebetween. The knee of the elevated leg 16 of the user 12 is arranged at the pad gap 74c such that direct pressure on the knee is prevented. The size of the pad gap 74c can be determined based on the particular user 12.

Referring now to the top plan view of FIG. 3, it can be seen that the first and second front wheel assemblies 26a and 26b are spaced from a center line A of kneeling walker 10 a distance greater than the spacing of the rear wheel assemblies 26c and 26d from the center line A. The spacing of the front wheels helps provide stability to the kneeling walker 10 during use.

The first and second wheel assemblies 26a and 26b are conventionally formed by wheels connected by an axle extending through a wheel support member 64. In this case, the wheels of the wheel assemblies 26a and 26b both rotate about a front wheel axis B.

Referring now to the first and second rear wheel assemblies 26c and 26d, the rear wheel assemblies 26c and 26d define first and second rear wheel axes C and D. The rear wheel assemblies 26c and 26d may be fixed wheels in which the wheel axes C and D are fixed relative to the frame 20. Alternatively, the wheel assemblies 26c and 26d may be moveable wheel assemblies that allow a position of the wheel axis C and D relative to the frame 20 to be changed. Yet another embodiment of the present invention may employ moveable wheel axes having a locking assembly that allows that rear wheel axes C and D to be selectively placed in fixed or moveable configurations relative to the frame. If the rear wheel axes C and D are moveable, the kneeling walker 10 is turned by rotating the rear of the walker 10 around the front of the walker 10.

From the foregoing, it should be clear that the present invention may be embodied in forms of most specifically described above. In particular, while the exemplary handle 22 comprises two handle post 82a and 82b, the frame may be configured such that the handle extends from a single handle post in a manner similar to that of a bicycle. Other alternations should be apparent to one of ordinary skill of the art, and the scope of the present invention should be determined by the claims appended hereto and not the foregoing detailed description.

I claim:

1. A walker system comprising:
a frame comprising a pad support;
a handle supported by the frame;
a plurality of wheel assemblies for supporting the frame;
a pad assembly comprising a pad member and a pad post, where the pad support slidably supports the pad post such that a position of the pad member relative to the frame can be changed; and
a post locking member for securing the pad post relative to the pad support to substantially fix the position of the pad member relative to the frame.

2. A walker system as recited in claim 1, in which:
the handle comprises at least one handle post and a handle member;
the frame further comprises at least one handle support, where the at least one handle support slidably supports the handle post such that a position of the handle member relative to the frame can be changed; and
the walker system further comprises a handle locking member for securing the handle post relative to the handle support to substantially fix the position of the handle member relative to the frame.

3. A walker system as recited in claim 1, in which:
the handle comprises first and second handle posts and a handle member;
the frame further comprises first and second handle supports, where the first and second handle supports slidably support the first and second handle posts such that a position of the handle member relative to the frame can be changed; and
the walker system further comprises first and second handle locking members for securing the first and second handle posts relative to the first and second handle supports to substantially fix the position of the handle member relative to the frame.

4. A walker system as recited in claim 1, in which:
the frame comprises first and second front leg portions, and first and second rear leg portions; and
the plurality of wheel assemblies comprise
first and second front wheel assemblies supported by the first and second front leg portions, and
first and second rear wheel assemblies support by the first and second rear leg portions.

5. A walker system as recited in claim 4, in which the frame comprises:
a front frame assembly comprising first and second hinge portions and the first and second front leg portions;
a handle frame assembly comprising third and fourth hinge portions and the first and second rear leg portions; and
at least one hinge member extending through the first, second, third, and fourth hinge portions such that the first and second frame assemblies may be rotated relative to each other to place the frame in one of a use configuration and a storage configuration.

6. A walker system as recited in claim 5, in which the frame further comprises at least one frame locking assembly for selectively locking the frame in the use configuration.

7. A walker system as recited in claim 6, in which the frame further comprises first and second frame locking assemblies for selectively locking the frame in the use configuration.

8. A walker system as recited in claim 5, in which the frame comprises first and second hinge members, where the first hinge member extends through the first and third hinge portions and the second hinge member extends through the second and fourth hinge portions.

9. A walker system as recited in claim 5, in which the front frame assembly comprises:
first and second handle frame side members;
a pad support assembly rigidly connected to the first and second handle frame side members, where the pad support assembly defines the pad support; and
a wheel support member rigidly connected to the first and second handle frame side members, where the wheel support member defines the first and second front leg portions.

10. A walker system as recited in claim 9, in which the pad support assembly comprises:
a pad support plate rigidly connected to the first and second handle frame side members; and
a pad support tube rigidly connected to the pad support plate, where the pad support tube is sized and dimensioned to receive the pad post.

11. A walker system as recited in claim 5, in which the handle frame assembly comprises:
first and second front frame side members, where the first and second front frame side members define the first and second rear leg portions, respectively;
a front brace member rigidly connected to the second frame side members; and
a rear brace member rigidly connected to the second frame side members.

12. A walker system as recited in claim 9, in which the handle frame assembly comprises:
first and second front frame side members, where the first and second front frame side members define the first and second rear leg portions, respectively;
a front brace member rigidly connected to the second frame side members; and
a rear brace member rigidly connected to the second frame side members.

13. A walker system as recited in claim 11, in which:
the handle comprises first and second handle posts and a handle member, where
the first and second front frame side members define first and second handle supports, respectively, and
the first and second handle supports slidably support the first and second handle posts such that a position of the handle member relative to the frame can be changed; and
the walker system further comprises first and second handle locking members for securing the first and second handle posts relative to the first and second handle supports to substantially fix the position of the handle member relative to the frame.

14. A walker system as recited in claim 5, in which the first, second, third, and fourth hinge portions are substantially parallel to each other when the walker system is in the use configuration.

15. A walker system as recited in claim 5, in which the front frame further comprises first and second front portions that extend from the hinge portions to the first and second front leg portions, respectively.

16. A walker system as recited in claim 9, in which the front frame further comprises first and second front portions that extend from the hinge portions to the wheel support member.

17. A method of supporting an elevated leg comprising the steps of:
providing a frame comprising a pad support;
supporting a handle on the frame;
providing a plurality of wheel assemblies for supporting the frame;
providing a pad assembly comprising a pad member and a pad post;
slidably supporting the pad post on the pad support such that a position of the pad member relative to the frame can be changed; and
securing the pad post relative to the pad support to substantially fix the position of the pad member relative to the frame at a desired location.

18. A method as recited in claim 17, in which:
the step of supporting the handle on the frame comprises the steps of providing at least one handle post and a handle member;
forming at least one handle support on the frame; and
slidably supporting the handle post on the at least one handle support such that a position of the handle member relative to the frame can be changed; and
the method further comprising the step of securing the handle post relative to the handle support to substantially fix the position of the handle member relative to the frame.

19. A walker system comprising:
a frame comprising a pad support and at least one handle support;
a handle comprising at least one handle post and a handle member, where the at least one handle support slidably supports the handle post such that a position of the handle member relative to the frame can be changed;
a plurality of wheel assemblies for supporting the frame;
a pad assembly comprising a pad member and a pad post, where the pad support slidably supports the pad post such that a position of the pad member relative to the frame can be changed; and
a handle locking member for securing the handle post relative to the handle support to substantially fix the position of the handle member relative to the frame.

20. A walker system as recited in claim 19, in which:
the handle comprises first and second handle posts and a handle member;
the frame further comprises first and second handle supports, where the first and second handle supports slidably support the first and second handle posts such that a position of the handle member relative to the frame can be changed; and
the walker system comprises first and second handle locking members for securing the first and second handle posts relative to the first and second handle supports to substantially fix the position of the handle member relative to the frame.
